(19) United States
(12) Patent Application Publication
(10) Pub. No.: US 2004/0032128 A1
(43) Pub. Date: Feb. 19, 2004

(54) Weak hi-bred automotive propulsion system

(76) Inventor: William Vincent Southard, New Bedford, MA (US)

Correspondence Address: WILLIAM VINCENT SOUTHARD, POST OFFICE BOX 6639, NEW BEDFORD, MA, 02742, US

(21) Appl. No.: 10/122,935

(22) Filed: Aug. 19, 2002

(51) Int. Cl. H02P 9/00

(52) U.S. Cl. 290/40 C

(57) ABSTRACT

What is new to the art of hi-bred vehicle design in my invention is the fact that my weak hi-bred design has to be recharged after it is used. This characteristic causes the vehicle to have greater efficiency without sacrificing too much practicality. The vehicle has the characteristic of a straight electric vehicle that has batteries that haven't been developed yet. It fills the void between current straight electric vehicles and the currently designed hi-bred.

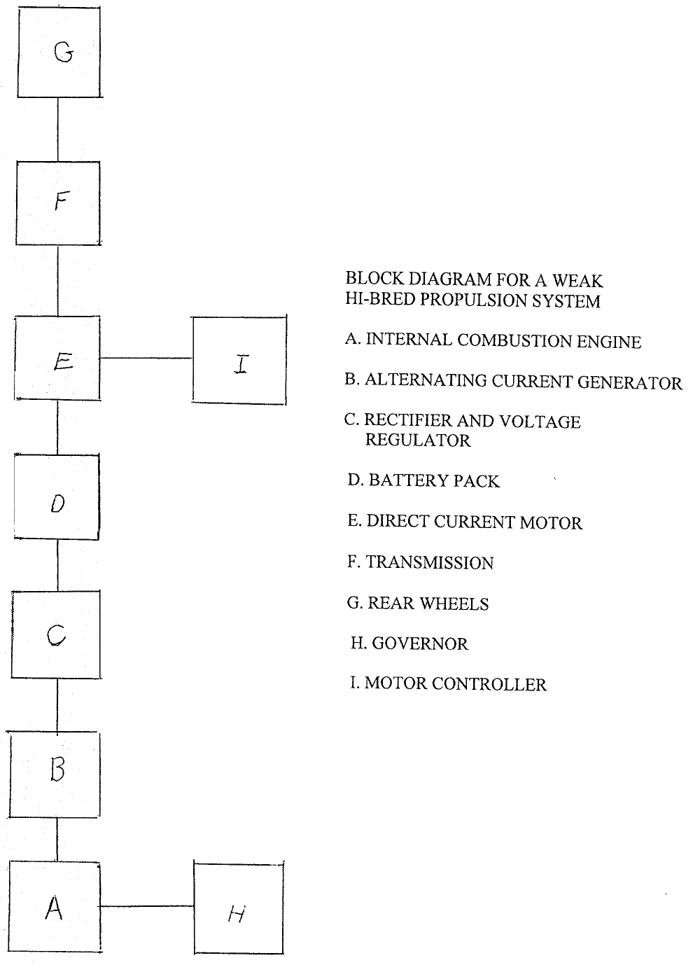

Also unique in my invention is the fact that the small engine used to operate this vehicle is constantly running and supplies less than average horsepower.

The most inefficient device ever devised by mankind is the internal combustion engine. As everybody knows, this device is about five percent efficient. This means that ninety five percent of the energy used to operate an automobile is wasted. There are two reasons why an internal combustion engine is inefficient. The first reason is that it is constantly changing rotational velocity. Most of the energy used to move an automobile is used when it is accelerating. Conversely, most of the energy used to move the engine parts is used when the engine is changing rotational velocity. That is, when the engine itself is accelerating. Another reason why the internal combustion engine is inefficient is, in order to operate an automobile properly, the engine has to be big enough to supply the maximum amount of horsepower that the automobile will need at any given time. This maximum horsepower is not needed very often, but the engine has to be big enough to supply this amount of horsepower when that time comes. Therefore, there are two reasons why the conventional automobile is inefficient.

1. The engine is constantly changing rotational velocity.

2. The engine needed to operate an automobile has to be big enough to supply the maximum amount of horsepower it will need at any given time.

In order to design an efficient system for an automobile using an internal combustion engine, the engine should be operated at a constant or near constant rotational velocity, and the engine should be just big enough to supply the average amount of horsepower that the automobile will need; not the maximum amount of horsepower that it will only occasionally require. These two goals can be reached with a hi-bred system The engine will operate a generator that will charge a battery pack while the automobile is in operation. At times when the automobile needs minimal horsepower and when it needs average horsepower, the direct current motor will receive energy from the alternating current generator. At these times, the battery pack will be charging or be near neutral. At times when the automobile needs above average horsepower or maximum horsepower, the direct current motor will receive energy from the alternating current generator and the battery pack. At these times, the battery pack will be discharging. This basic hi-bred system will be more efficient than the conventional automobile. There is however an even more efficient system to operate an automobile. This system is what I call a weak hi-bred. A weak hi-bred is similar to a basic hi-bred, with the following exceptions.

1. The engine will supply less than average horsepower.

2. The battery pack will eventually run down in constant operation.

This system will be more efficient than a basic hi-bred because it will use only the amount of energy that is needed and no more. The battery pack can be recharged in one of two ways. The battery pack can be recharged by parking the automobile and letting the engine run until the battery pack is charged or by plugging the battery pack into house current when this is practical. The range for a weak hi-bred should be about 500 miles. This vehicle can also be operated as a straight electric automobile by not using the engine at all. In this mode, the automobile can be used for errands around town and for short commutes. The range for a weak hi-bred used as a straight electric automobile should be about 100 miles.

This vehicle can be used on trips. If a stop is made for lunch, the engine can be kept running and thereby increase the range. At the end of a day's driving, the engine can be left running until the battery pack is recharged. The engine is small enough and quiet enough not to bother anybody if left running in a motel parking lot. When the battery pack is recharged, the engine will turn off automatically. A weak hi-bred is therefore more efficient than a basic hi-bred. A weak hi-bred will have a range that is large enough for practical operation. A weak hi-bred will also have the advantage of being able to be used as a straight electric vehicle. This petition is therefore being made for what I call a weak- hi-bred system.

1. I first became interested in Hi-Bred vehicles in 1962, when I was a student at Wentworth Institute of Technology in Boston. I was in the class for Electrical Engineering Technology. I did in fact write a paper for a class in which I did design a Hi-Bred vehicle. In 1962, however, gasoline was 30 cents a gallon, and battery technology was not advanced enough to make the design practical. I personally also never had the resources to actually build one myself, although I always wanted to do that.
Recently I read an article in Popular Mechanics, describing how the Hi-Bred from Japan functioned. I couldn't help noticing that my design was very different from the design that I read about. I also believe that my design is basically more efficient.
The difference between what I read about and my design is that; my design has a constantly running small internal combustion engine that will supply slightly less than average horsepower. This design will produce maximum efficiency because only the horsepower that is needed to operate the vehicle will be produced. Another reason that this design is efficient is that the engine itself is not changing rotational velocity. The current designs that are on the market have the small engine going on and off. By turning the small engine on and off, energy is being wasted to accelerate the parts of the engine.
When the car is parked, the small engine will continue to run until the battery pack is recharged. Therefore, exactly the amount of energy that was used on the trip will be produced. The vehicle can be plugged in to house current as an option because it isn't practical to keep the engine running inside a garage. When the vehicle is used only as an electrical vehicle, and the battery pack is recharged; then too will only the amount of energy that was used be produced. Current designs of hi-bred vehicles by necessity have internal combustion engines that produce above average horsepower. If the engine produces above average horsepower, energy will be wasted to operate the engine itself. The key to efficiency for a hi-bred vehicle is to have a small as possible internal combustion engine and to operate this engine at a constant rotational velocity.
The key calculation for a hi-bred design is the figure for average horsepower. This number is hard to calculate. This number will vary because of the size and function of the vehicle and by different driving conditions. This number can only be estimated. The engine supplied to the vehicle can be higher or lower that the average horsepower. If it is higher, maximum efficiency can't be achieved. That is the reason why I believe that my weak hi-bred is unique and able to be patented.
